(19) United States
(12) Patent Application Publication
(10) Pub. No.: US 2010/0038400 A1
(43) Pub. Date: Feb. 18, 2010

(54) ALIGNING AND LOCATING DEVICE

(76) Inventor: Charles Dale Ramsden, Johannesburg (ZA)

Correspondence Address: FROMMER LAWRENCE & HAUG, 745 FIFTH AVENUE- 10TH FL., NEW YORK, NY, 10151, US

(21) Appl. No.: 12/522,983

(22) PCT Filed: Jan. 15, 2008
(86) PCT No.: PCT/IB08/50121

§ 371 Date: Aug. 5, 2009

(30) Foreign Application Priority Data
Jan. 15, 2007 (ZA) 2007/00440

(51) Int. Cl. B25C 7/00; B25C 5/00

(52) U.S. Cl. 227/151; 227/155

(57) ABSTRACT

An aligning and locating device (22) is provided. The device comprises a base portion (28) to be secured to a foot portion (24) of a stapler (26), the base portion (28) including two locating legs (38) defining a receiving cavity (36) between them. The receiving cavity (36) receives and aligns a locating formation of a corner device (10) in use. The device further comprises two upright aligners (30) extending from the base portion (28), the aligners defining between them an aligning cavity (34) for receiving a portion of a document. A lip (40) extends over the receiving cavity (36) to hold the corner device (10), in use, in position relative to the stapler (26) and the aligned document.

### BACKGROUND OF THE INVENTION

THIS invention relates to an aligning and locating device for use with a corner device.

A corner device as described in PCT/IB2005/00175 is typically attached to a corner of an article, such as a document formed by a sheet or sheets of paper. An aim of the present invention is to provide an aligning and locating device to be used with such a corner device.

A prior art corner device locator is described in PCT/IB2005/00175, which corner device locator is secured to the magazine of a stapler. This makes it necessary in certain circumstances to either adapt the stapler or to use a rivet to attach the corner device locator to the magazine of the stapler. In use, the corner device is received by the prior art corner device locator and the corner device is then secured to the document by moving the magazine of the stapler down, actuating the stapler, with the legs of a staple being received on opposed sides of the corner device when attached to the document. However, a need has been identified not to have the corner device received by a device or locator that forms part of, or is attached to, a moving part, e.g., the magazine, of the stapler.

It is an object of the present invention to provide an alternative locating and aligning device for use with a corner device.

### SUMMARY OF THE INVENTION

According to the present invention there is provided an aligning and locating device comprising:
a base portion to be secured to a foot portion of a stapler, the base portion including two locating legs defining a receiving cavity between them, wherein the receiving cavity receives and aligns a locating formation of a corner device in use; and
two upright aligners extending from the base portion, defining an aligning cavity for receiving a portion of, and aligning, a document,
wherein the configuration of the receiving cavity and aligning cavity allows the corner device to be held in position, in use, relative to the stapler and the aligned document.

Preferably, the aligning and locating device further comprises a lip extending over the receiving cavity to securely hold the corner device, in use, in position relative to the stapler and the aligned document.

It will be appreciated that the aligning cavity aligns the document relative to the stapler, once received by the aligning cavity.

Typically the lip is biased downward towards the foot portion of the stapler to hold the corner device securely in place once it has been received by the receiving cavity.

Preferably the lip may include a securing formation to further assist in holding the corner device in place in the receiving cavity. The securing formation may be a protrusion or rib that extends into the receiving cavity.

Advantageously the aligning and locating device may include attachment means to secure the aligning and locating device to the foot portion of the stapler.

The attachment means may include a protruding formation.

Alternatively, the attachment means includes a shaft extending through the foot portion of the stapler and a stop to secure the shaft in place. Preferably the shaft has an undercut formation and the stop is received by this formation.

Preferably, the stapler is actuated once the corner device is held in position relative to the stapler and the aligned document.

According to another aspect of the invention there is provided a stapler including an aligning and locating device as defined above.

The aligning and locating device may include a staple deformation portion which has a depression to receive and deform the legs of a staple when the stapler is actuated.

According to yet another aspect of the invention there is provided an aligning and locating device for use with a corner device which includes a main body, a locating formation and a neck connecting the locating formation to the main body, wherein the aligning and locating device comprises a base portion, two locating legs which are substantially coplanar with the base portion, which legs extend from the base portion and which define, between them, a receiving cavity which, in use, receives the locating formation of the corner device, the aligning and locating device further comprising at least two aligners which project from the base portion and which define an aligning cavity between them which, in use, receives a corner of a document which overlies the corner device.

The aligning and locating device may be adapted to be secured to a stapler, which stapler is actuated to drive legs of a staple through the document, adjacent the neck of the corner device, and to deform the legs of the stapler thereby to secure the corner device to the document.

### BRIEF DESCRIPTION OF THE DRAWINGS

FIG. 1 shows a corner device according to the prior art, the corner device having a main body and a locating formation;

FIG. 2 is a perspective view of an aligning and locating device according to an example embodiment of the invention, the device being attached to a stapler;

FIG. 3 is a bottom view of the aligning and locating device according to FIG. 2;

FIG. 4 shows the corner device of FIG. 1 located in a receiving cavity of the aligning and locating device of FIG. 2;

FIG. 5 is a perspective view of sheets of paper aligned by the aligning and locating device of FIG. 3, with the corner device secured to the sheets of paper by a staple;

FIG. 6 shows an upper surface of the sheets of paper, with the corner device secured to the sheets of paper;

FIG. 7 shows the corner device of FIG. 1 folded over itself into its operative position;

FIG. 8 is a cross-sectional view of the corner device of FIG. 7 on an enlarged scale in its operative position;

FIGS. 9a and 9b are respective perspective and cross-sectional views of another embodiment of an aligning and locating device according to the present invention, where the aligning and locating device forms part of a staple deformer portion of a stapler.

### DESCRIPTION OF PREFERRED EMBODIMENTS

FIG. 1 shows a corner device 10 according to the prior art, as described in PCT/IB2005/00175, the contents of which document are hereby incorporated by reference.

The corner device 10 includes a main body 12 and a locating formation 14. In use, the corner device 10 is attached to an article, typically a corner of a document formed by a sheet of paper or sheets of paper. The main body 12 of the corner device 10 therefore may in one embodiment have a substantially triangular shape to neatly fit over a corner of the document once attached thereto. It will be appreciated that the corner device may have other shapes that may substantially cover the corner of a document, as illustrated by further embodiments.

The locating formation 14 of the corner device 10 has a neck 16 connecting the locating formation 14 to the main body 12. On either side of the neck 16 a narrow channel 18 is defined by the locating formation 14 and the main body 12. The configuration of the neck 16 and narrow channels 18 ensures that the distance between the two legs of a staple are greater than the width of the neck 16 thereby ensuring that the staple does not puncture the corner device 10.

Typically, the upper surface of the main body 12 of the corner device 10 carries information or a decorative/ornamental design or pattern. This information, design or pattern is displayed to a user when the corner device 10 is folded over itself into its operative position and secured to the document. This process will be described in more detail later. An example of a decorative pattern that may be carried on the upper surface of the main body 12 is a company logo. Such a logo attached to a document would immediately inform the receiver thereof that the specific company has issued the document. Alternatively, information such as “Contract” or “Legal Document” may be printed on the corner device 10 thereby to indicate the type of document to which the corner device 10 is attached.

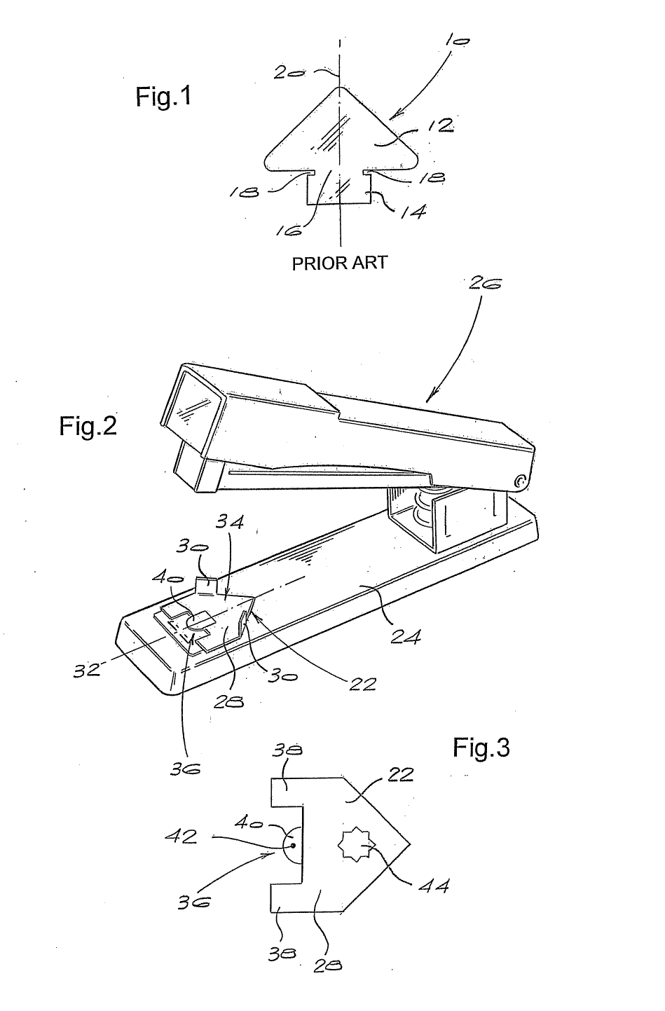

In use the corner device 10 is secured with a staple to a document consisting of a sheet or sheets of paper with a staple. The corner device 10 is attached to a corner of the document, with a central axis 20 of the corner device 10 at an angle of approximately 45° to adjacent edges of the document by using an aligning and locating device 22 of the type shown in the example embodiment of FIGS. 2 to 5. This alignment is preferable, especially in instances where the main body 12 is substantially triangular, as the installed corner device 10 would cover the corner of the document. The corner device may be used as a decorative feature to the document and may additionally provide the document with security features.

The aligning and locating device 22 will now be described with reference to FIGS. 2 to 5.

Referring to FIGS. 2 and 3, the aligning and locating device 22 includes a base portion 28 that is secured to a foot portion 24 of a stapler 26. Two upright aligners or brackets 30 extend from the base portion 28. Each of the upright brackets 30 is located at an angle of approximately 45° to a central axis 32 extending longitudinally through the aligning and locating device 22, as indicated in FIG. 2. The two brackets 30 define an aligning cavity 34, (best shown in FIG. 5) being a right-angled cavity, to receive a corner of the document, thereby aligning the document in respect of the stapler and corner device.

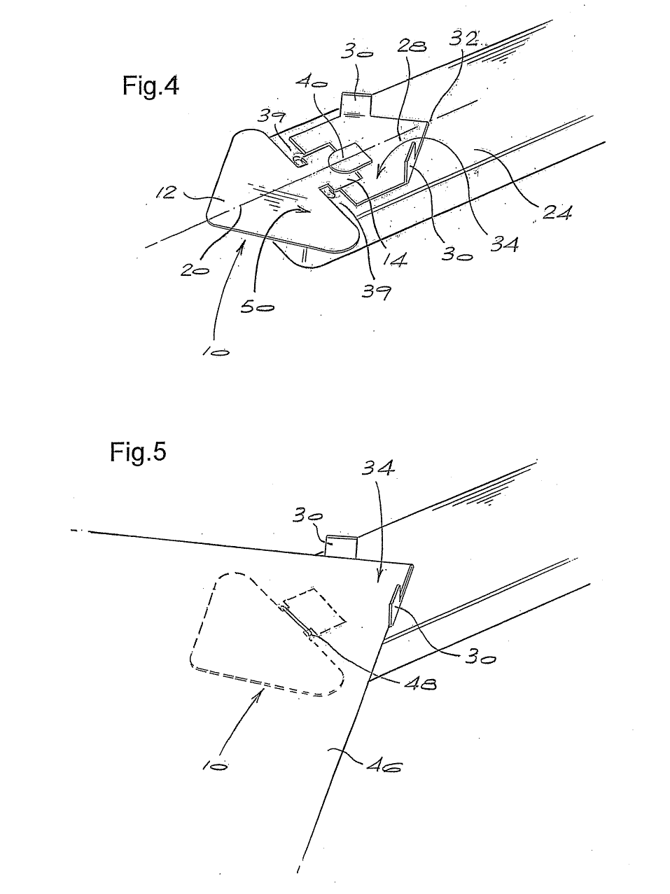

The base portion 28 of the aligning and locating device 22 includes two legs 38 which define a receiving cavity 36 between them. The receiving cavity 36 has a predetermined length and width to receive at least a portion of the locating formation 14 of the corner device 10. As shown in FIG. 4, the length of the receiving cavity 36 will typically be shorter than the length of the locating formation 14 and neck 16, thereby to ensure that the narrow channels 18 on the sides of the neck 16 are located over the stapler's staple deforming portion in use. In this configuration, when the portion of the locating formation 14 of the corner device 10 is received by the receiving cavity 36, spaces 39 (shown in FIG. 4) are left between the opposing edges of the main body 12 of the corner device 10 and the ends of the legs 38 of the aligning and locating device 22. These spaces form gaps on either side of the locating formation 14 and neck 16 to receive the staple. This configuration holds the corner device 10 in position and aligns it with the sheets of paper, thereby allowing the legs of a staple to pass through the narrow channels 18 of the corner device 10, now located adjacent the ends of the two legs of the aligning and locating device 22, when the stapler 26 is actuated.

The aligning and locating device 22 also includes a holding lip 40 that extends over the receiving cavity 36. This lip 40 may be biased downward towards the foot portion 24 of the stapler 26 (into the receiving cavity 36) to hold the corner device 10 in place once it has been received by the receiving cavity 36. Alternatively, or in addition to the bias, the lip 40 may include a securing formation 42 in the form of a protrusion or rib that extends into the receiving cavity 36. This securing formation 42 acts as a friction grip to assist in holding the corner device 10 in place in the receiving cavity 36.

As shown in FIG. 3, the aligning and locating device 22 includes attachment means 44 to secure the aligning and locating device 22 to the foot portion 24 of the stapler 26. In one example embodiment, the attachment means 44 is in the form of a protruding formation which extends at least partially through the foot portion 24 of the stapler 26. The attachment means 44 has a secure fit with the foot portion 24 of the stapler 26 to ensure that the aligning and locating device 22 does not lift up or detaches from the stapler when the stapler is actuated. The protruding formation 44 may accordingly have an outwardly biased mechanism that expands outwardly, creating a friction hold on the foot portion 24 of the stapler. It will be appreciated that any attachment means securing the aligning and locating device to the foot portion 24 of the stapler 26 can be used.

It will be appreciated that the aligning and locating device 22 may be sold separately from a stapler. In order to adapt a stapler to be used with an aligning and locating device 22, the aligning and locating device 22 may be sold with a punch. This punch may then be used to punch a suitable complementary cavity into the foot portion 24 of the stapler to be used with the aligning and locating device 22.

As mentioned, the aligning and locating device 20 facilitates the proper alignment of the corner device 10 with the document and the stapler 26 thereby ensuring that the corner device is correctly attached to the document.

The aligning and locating device 22 is typically manufactured from metal, a resin, plastic material or any other material that is strong and durable and could be secured to the stapler 26. The material should also preferably have a limited resilience to be able to hold the corner device 10 in place.

The steps of attaching the corner device 10 to the sheets of paper, using the aligning and locating device 22, will now be discussed with reference to FIGS. 4 to 7. FIG. 4 shows the aligning and locating device 22 secured to the foot portion 24 of the stapler 26. The corner device 10 is located and aligned by the aligning and locating device 22, with the receiving cavity 36 receiving the end portion of the locating formation 14 of the corner device 10. Typically, the lip 40 will be biased downward and/or, with the securing formation 42, holds the corner device 10 in place in the receiving cavity 36, prior to attaching the corner device to the sheets of paper 46. The securing formation 42 will in these circumstances abut the locating formation 14 of the corner device 10, thereby acting as a friction grip.

The central axis 20 of the corner device 10 and the central axis 32 extending longitudinally through the aligning and locating device 22 correspond in this configuration, allowing the sheets of paper 46 to be aligned at an approximate angle of 45° with the stapler's foot portion 24.

As shown in FIG. 5, the corners of the sheets of paper 46 are received by the aligning cavity 34 defined by the two brackets 30.

In FIG. 5, the corner device 10 has been attached by a staple 48 to the sheets of paper 46. As will be appreciated, the staple 48 is attached to the sheets of paper 46 by actuating the stapler 26, with the legs of the staple 48 being forced through the paper 46 and then respectively passing through the narrow channel 18 defined by the corner device 10. The two legs of the staple 48 have thus been received by the two narrow channels 18, thereby allowing the corner device 10 to be attached to the paper 44 without being punctured by the staple. The locating formation 14 extends beyond the staple 48, thereby ensuring that the corner device 10 is held in place by the staple 48.

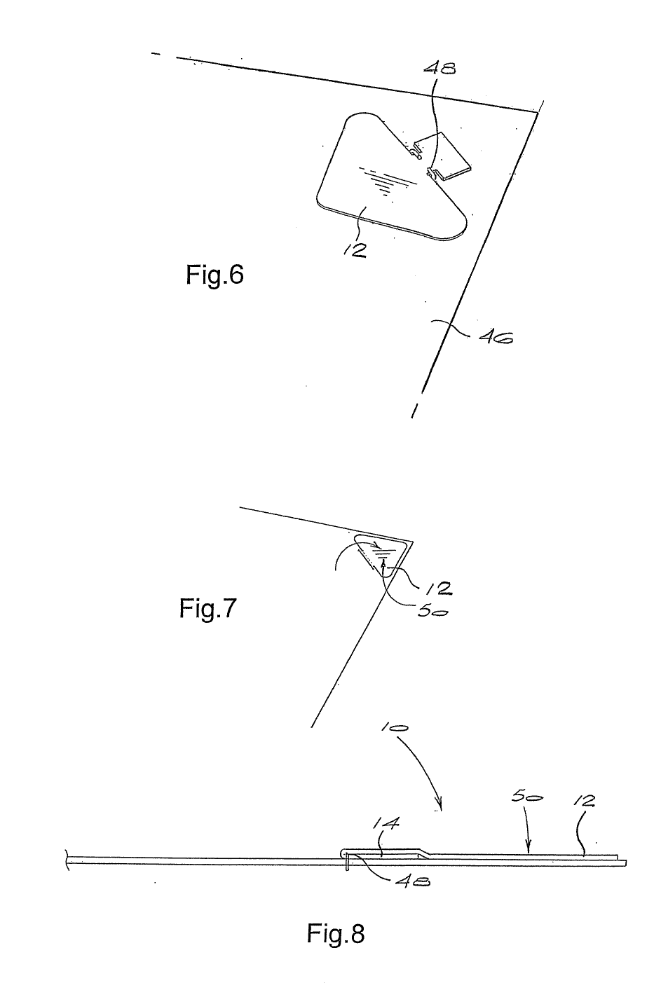

To ensure proper application of the corner device 10 to the sheets of paper 46, the corner device 10 should be fed into the aligning and locating device 22 with its upper surface 50, carrying information, a decorative or ornamental design or pattern, facing upwards, away from the foot portion 24 of the stapler 26. The document comprising the sheets of paper 46 will then be placed upside down in the aligning cavity 34, in order for the upper surface 50 of the corner device 10 to face towards the upper surface of the first sheet of paper. When the document is turned around, as shown in FIG. 6, the upper surface 50 of the corner device 10 faces down. The two legs of the staple 48 now extend through the paper to the first sheet of the document and are cramped onto the first sheet.

FIGS. 7 and 8 show the main body 12 of the corner device 10 folded or bent over the cramped legs of the staple 48 and the locating formation 14. The corner device 10 is now located over the corner of the sheets of paper 46, with the upper surface 50 of the corner device facing upwards. The neck 16 of the locating formation 14 forms a folding area which makes it easier to fold the main body 12 back over the locating formation 10.

As described in PCT/IB2005/00175 the corner device may have further features and may include attachment means, such as an adhesive layer, on the bottom surface or underside of the main body 12 of the corner device 10. Once the corner device 10 is secured to the sheets of paper, a backing paper layer (applied over the adhesive layer) is removed, the main body 12 is folded back on the locating formation 14 and the main body 12 is then adhered to the top sheet of the sheets of paper with the locating formation 16 now being between the main body 12 and the sheets of paper. As the main body 12 is folded over the cramped legs of the staple and attached to the sheets of paper, the staple cannot be removed without damaging the document. This provides a tamper-evident corner device 10 which is thus usable as a seal.

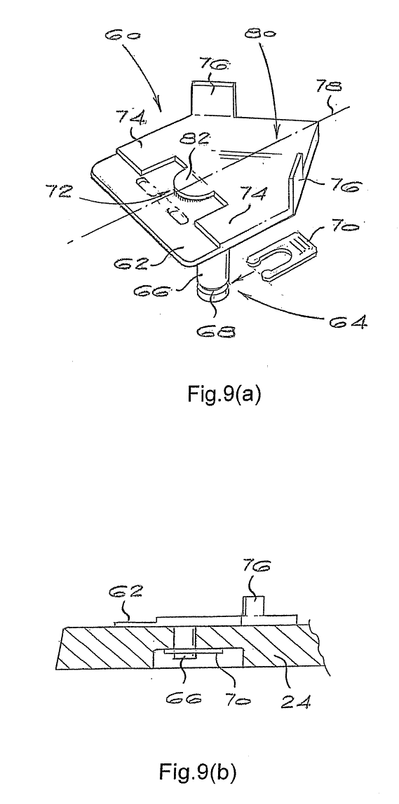

According to a further embodiment of the invention, there is provided an aligning and locating device 60 which forms part of a stapler. As shown in FIGS. 9a and 9b, the aligning and locating device 60 is integral with a staple deformer portion of the stapler. In this embodiment the aligning and locating device 60 includes a base portion forming a staple deformer portion 62. The staple deformer portion 62 has a depression to receive and deform the legs of a staple during the actuation process of the stapler. The aligning and locating device 60 further includes attachment means 64 that extends through the stapler foot portion 24. The attachment means 64 includes a shaft 66 with an undercut formation 68 and a stop 70 which can be clipped onto the formation 68. It will be appreciated that the attachment means may vary. For example, the attachment means may include a shaft with internal threading to receive a stop in the form of a screw. It will also be appreciated that the attachment means described above may be used as attachment means for the embodiment described according to FIGS. 2 to 6.

A receiving cavity 72 is formed between two legs 74 located on the upper surface of the aligning and locating device 60. The legs may form a raised area around the receiving cavity 72.

Two upright aligners or brackets 76 extend from the base portion. Each bracket 76 is located at an angle of approximately 45° to a central axis 78 extending longitudinally through the aligning and locating device. The two brackets 76 define an aligning cavity 80, to receive a corner of the document.

The aligning and locating device 60 also includes a holding lip 82 that extends over the receiving cavity 72. The receiving cavity 72 with the holding lip 82 holds and aligns the corner device in place during the stapling process.

It will be appreciated that the aligning and locating device may be adapted to secure a corner device to a side of a document. In such an embodiment the two upright aligners may be located next to each other to restrict the movement of the document and to locate the side of the document at a predetermined distance over the staple deformer portion. This distance will depend on the length of the locating formation and main body of the corner device, as the corner device should be positioned to be folded over the locating formation and to fit properly on the side of the document. The upright aligners or brackets define an open aligning cavity in this embodiment and will extend next to the magazine of the stapler, when the stapler is actuated. As with the other embodiments, a receiving cavity and holding lip to receive and hold the corner device, will be defined in the front end of the aligning and locating device.

Once the corner device is secured to the sheets of paper with the staple and the adhesive layer, it would be difficult to remove the staple from the sheets of paper without damaging the corner device. To remove the staple, one would first have to detach the main body 12 from the sheets of paper. Provided that a strong adhesive is used, this would result in sheets of paper tearing. Also, where the main body has two arms which are secured to the back of the last sheet of paper, these arms will have to be detached from the sheets of paper, further destroying the corner device and thereby indicating that the corner device and document have been tampered with.

1. An aligning and locating device comprising:
a base portion to be secured to a foot portion of a stapler, the base portion including two locating legs defining a receiving cavity between them, wherein the receiving cavity receives and aligns a locating formation of a corner device in use;
two upright aligners extending from the base portion, the aligners defining between them an aligning cavity for receiving a portion of, and aligning, a document,
wherein the configuration of the receiving cavity and aligning cavity allows the corner device to be held in position, in use, relative to the stapler and the aligned document.

2. An aligning and locating device according to claim 1 further comprising a lip extending over the receiving cavity to securely hold the corner device, in use, in position relative to the stapler and the aligned document.

3. An aligning and locating device according to claim 2 wherein the lip is biased towards the foot portion of the stapler to hold the corner device securely in place once it has been received by the receiving cavity.

4. An aligning and locating device according to claim 2 wherein the lip includes a securing formation to assist in holding the corner device in place in the receiving cavity.

5. An aligning and locating device according to claim 4 wherein the securing formation is a protrusion or rib that extends into the receiving cavity.

6. An aligning and locating device according to claim 1 further comprising attachment means to secure the aligning and locating device to the foot portion of the stapler.

7. An aligning and locating device according to claim 6 wherein the attachment means is a protruding formation to extend at least partially into the foot portion of the stapler.

8. An aligning and locating device according to claim 6 wherein the attachment means includes a shaft extending through the foot portion of the stapler and a stop to secure the shaft in place.

9. An aligning and locating device according to claim 8 wherein the shaft has an undercut formation and the stop is engaged therewith.

10. An aligning and locating device according to claim 1 further comprising a staple deformation portion which has a depression to receive and deform the legs of a staple when the stapler is actuated.

11. A stapler comprising an aligning and locating device as claimed in claim 1.

12. An aligning and locating device for use with a corner device which includes a main body, a locating formation and a neck connecting the locating formation to the main body, wherein the aligning and locating device comprises a base portion, two locating legs which are substantially coplanar with the base portion, which legs extend from the base portion and which define, between them, a receiving cavity which, in use, receives the locating formation of the corner device, the aligning and locating device further comprising at least two aligners which project from the base portion and which define an aligning cavity between them which, in use, receives a corner of a document which overlies the corner device.

13. An aligning and locating device according to claim 12 wherein the aligning and locating device is adapted to be secured to a stapler, which stapler is actuated to drive legs of a staple through the document, adjacent the neck of the corner device, and to deform the legs of the stapler thereby to secure the corner device to the document.
